(19) United States
(12) Patent Application Publication
(10) Pub. No.: US 2008/0153487 A1
(43) Pub. Date: Jun. 26, 2008

(54) User Defined Location Based Zones

(76) Inventors: Daryl Joseph Martin, Paradise (CA); Christopher David O'Keefe, St. John's (CA); Ahmed E. Hassan, Waterloo (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, omitted

(21) Appl. No.: 11/614,194

(22) Filed: Dec. 21, 2006

(51) Int. Cl. H04Q 7/20

(52) U.S. Cl. 455/435.1

(57) ABSTRACT

A method is provided for creating a custom zone in order to an improve the graphical user interface for a user of a mapping application on a mobile device. The method comprising the steps of: requesting creation of the custom zone; establishing a location of the custom zone; defining a boundary for the custom zone; and associating multimedia data with the custom zone for subsequent display to the user. A further method is described for displaying the custom zone to the user. A system and computer readable medium configured to implement the method are also described.

The present disclosure relates generally to mapping applications and specifically to providing information to users of such applications in accordance with user defined zones.

### BACKGROUND

With the recent advancements of Global Positioning System (GPS) devices, integration between compact GPS receivers and mobile devices, such as cell phones and portable digital assistants (PDAs), is becoming popular. This merger of technology provides many different possibilities for users of the mobile devices, as their devices can perform tasks that were not previously possible. However, in many cases a user interface to GPS functionality in the mobile devices is not as robust as it could be and, in some cases, provides a bad user experience.

One problem in particular is the limitation of displaying longitudinal and latitudinal data to the users as a location on a map. While this is useful when the user needs directions, there are many times when the user does not need directions. Further, there are times when a user may want information in addition to their location on the map. Accordingly, an improved interface is desired so that the experience of interacting with the GPS is cleaner, more fun, and something the user would like to use.

### BRIEF DESCRIPTION OF THE DRAWINGS

Embodiments will now be described by way of example only with reference to the following drawings in which:

FIG. 1 is a block diagram illustrating a telecommunication infrastructure (prior art);

FIG. 2 is a block diagram illustrating components of a mobile device;

FIG. 3 is a flow diagram illustrating the steps for creating a custom zone; and

FIG. 4 is a flow diagram illustrating the steps for displaying the custom zone.

### DETAILED DESCRIPTION OF THE PREFERRED EMBODIMENTS

In accordance with one embodiment there is provided a method of creating a custom zone for providing an improved graphical user interface to a user of a mapping application on a mobile device, the method comprising the steps of: requesting creation of the custom zone; establishing a location of the custom zone; defining a boundary for the custom zone; and associating multimedia data with the custom zone for subsequent display to the user.

In accordance with a further embodiment there is provided a method for providing an improved graphical user interface to a user of a mapping application for identifying a predefined custom zone on a map, the method comprising the steps of: determining that the custom zone is included in a portion of the map to be displayed by the mapping application; retrieving multimedia data associated with the custom zone; and displaying the multimedia data to the user.

In accordance with yet a further embodiment, there is provided a computer readable medium which comprises instructions for executing the methods described above.

In accordance with yet a further embodiment, there is provided a system for providing an improved graphical user interface to a user of a mapping application on a mobile device for identifying a predefined custom zone on a map, the system comprising a processor configured to implements the steps of: determining that the custom zone is included in a portion of the map to be displayed by the mapping application; and retrieving multimedia data associated with the custom zone for display to the user.

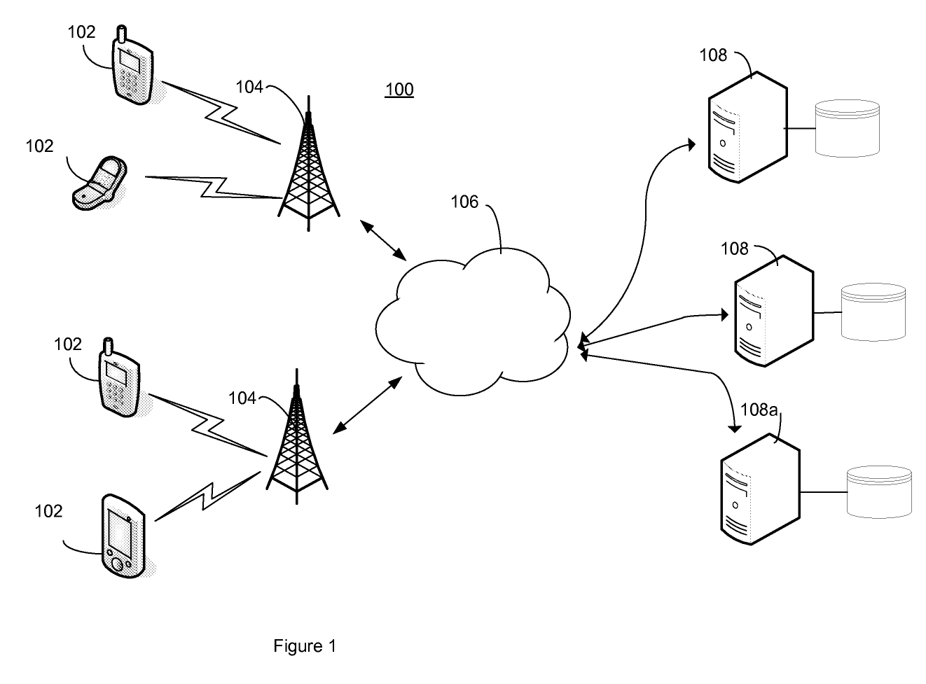

For convenience, like numerals in the description refer to like structures in the drawings. Referring to FIG. 1, a typical telecommunication infrastructure is illustrated generally by numeral 100. The telecommunication infrastructure 100 includes a plurality of mobile devices 102, a plurality of base stations 104, a communication network 106 and a plurality of network servers 108.

The mobile devices 102 include wireless computing devices such as a smart phone, a personal digital assistant (PDA), a GPS enabled trip computer in a vehicle and the like. The mobile devices 102 are in communication with one of the base stations 104. The base stations 104 relay data between the mobile devices 102 and the network servers 108 via the communication network 106. Accordingly, the communication network 106 may include several components such as a wireless network, a relay, a corporate server and/or a mobile data server for relaying data between the base stations 104 and the network servers 108.

The network servers 108 include servers such as a Web server, an application server, and an application server with web services. An example of an application server 108 is a location based server 108a. Location based servers 108a use position information relating to a user's location with intelligent applications and solutions to provide relevant information and services to the user. For example, a mapping application executing on the mobile device 102 may retrieve relevant mapping data for presenting to the user. The location based server 108a uses the position of the mobile device 102 to assist in determining the appropriate mapping data to transmit.

It will be appreciated by a person of ordinary skill in the art that the telecommunication infrastructure 100 described herein is exemplary and that changes may be made to one or more components to accommodate different network configurations without affecting the scope of the invention described and claimed herein.

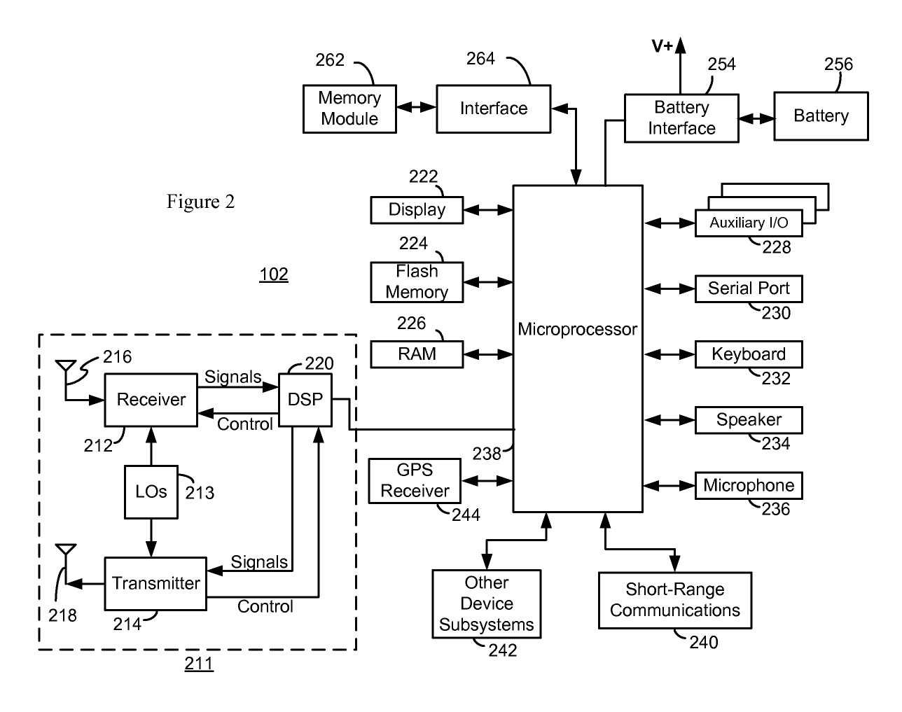

Referring to FIG. 2, a mobile device 102 is illustrated in greater detail. The mobile device 102 is often a two-way communication device having both voice and data communication capabilities, including the capability to communicate with other computer systems. Depending on the functionality provided by the mobile device 102, it may be referred to as a data messaging device, a two-way pager, a cellular telephone with data messaging capabilities, a wireless Internet appliance, or a data communication device.

The mobile device 102 includes a communication subsystem 211, which includes a receiver 212, a transmitter 214, and associated components, such as one or more embedded or internal antenna elements 216 and 218, local oscillators (LOs) 213, and a processing module such as a digital signal processor (DSP) 220. As will be apparent to those skilled in field of communications, the particular design of the communication subsystem 211 depends on the communication network in which mobile device 102 is intended to operate.

The mobile device 102 includes a microprocessor 238 which controls general operation of the mobile device 102. The microprocessor 238 also interacts with additional device subsystems such as a display 222, a flash memory 224, a random access memory (RAM) 226, auxiliary input/output (I/O) subsystems 228, a serial port 230, a keyboard 232, a speaker 234, a microphone 236, a short-range communications subsystem 240 such as Bluetooth™ for example, and any other device subsystems or peripheral devices generally designated at 242. The mobile device 102 also includes a positioning device 244 for receiving positioning information.

The positioning device 244 may be a receiver, such as a GPS receiver for example, for receiving satellite broadcasts. In one embodiment, the satellite broadcast data is used by the mobile device 102 to determine its position. In another embodiment, the satellite broadcast data is transmitted from the mobile device 102 to one of the network servers 108 to determine the position of the mobile device 102. One such technique is known as assisted-GPS. In assisted-GPS, signalling information from a position determining entity is provided to the mobile device 102 to aid in position determination. As long as the mobile device 102 can connect with the network server 108, it can query its location from the network server 108.

Alternatively, the positioning device 244 may comprise a positioning module for receiving positioning information from one of the network servers 108. In this embodiment, the positioning module may comprise a software, rather than a hardware, solution.

Operating system software used by the microprocessor 238 is preferably stored in a persistent store such as the flash memory 224, which may alternatively be a read-only memory (ROM) or similar storage element (not shown). Those skilled in the art will appreciate that the operating system, specific device applications, or parts thereof, may be temporarily loaded into a volatile store such as RAM 226.

The microprocessor 238, in addition to its operating system functions, preferably enables execution of software applications on the mobile device 102. A predetermined set of applications, which control basic device operations, is installed on the mobile device 102 during its manufacture. These basic operations typically include data and voice communication applications, for example. Additionally, applications may also be loaded onto the mobile device 102 through the network 106, an auxiliary I/O subsystem 228, serial port 230, short-range communications subsystem 240, or any other suitable subsystem 242, and installed by a user in RAM 226, or preferably the persistent store 224, for execution by the microprocessor 238. Such flexibility in application installation increases the functionality of the mobile device 102 and may provide enhanced on-device features, communication-related features, or both.

The display 222 is used to visually present an application's graphical user interface (GUI) to the user. The user can manipulate application data by modifying information on the GUI using an input device such as the keyboard 232 for example. Depending on the type of mobile device 102, the user may have access to other types of input devices, such as, for example, a scroll wheel, trackball, light pen or touch sensitive screen.

In accordance with the present embodiment, a zone application is installed on the mobile device 102 for providing the user with an improved interface for location based services, such as a GPS mapping application. The zone application can be implemented as a standalone, or plug-in, application that interfaces with a pre-existing mapping application or it can be incorporated into a new mapping application, as will be appreciated by a person of ordinary skill in the art.

The zone application provides the user with the ability to define one or more custom zones that are of relevance to the user. Each of the custom zones is defined by the user dynamically assigning a boundary to a region or area of interest. For example, the user can define a home zone comprising a local neighbourhood including the user's home address. As another example, the user can define a work zone comprising a local neighbourhood including the user's work address. Accordingly, it can be seen that the user can define a number of custom zones, as desired.

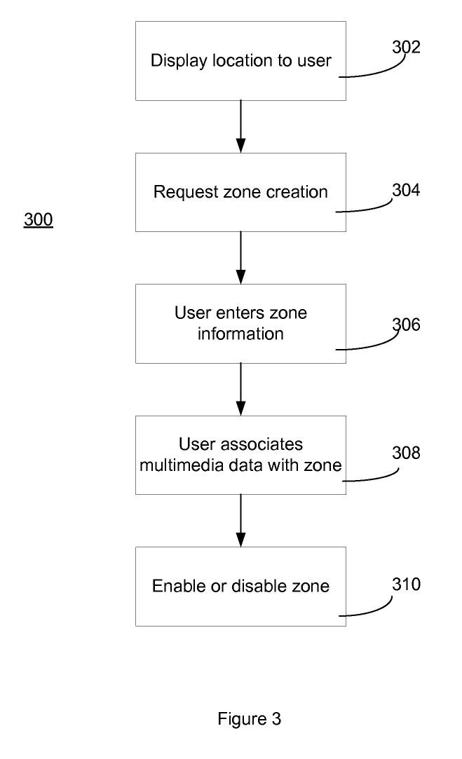

Referring to FIG. 3, a flow chart illustrating the steps used to create a custom zone is shown generally by numeral 300. In step 302, the user is presented with graphical or numerical representation of the user's location. In step 304, the user requests creating a custom zone using the zone application on the mobile device 102. As will be appreciated, this step can be implemented a number of different ways using the GUI on the mobile device 102.

In one embodiment, the user can actively seek to create a custom zone by selecting a “Create Zone” option provided in a menu list.

In another embodiment, the zone application can prompt the user with an option to create a custom zone upon arrival at a predefined location. In this embodiment, the zone application can include a list of locations predefined by the user. Alternative, the zone application can interface with a contact application to retrieve a list of locations. The retrieved list of locations may include, for example, all addresses in the contact application. Alternatively, the retrieved list may be filtered in accordance with user preferences.

In step 306, the zone application prompts the user for a name and boundary for defining the custom zone. The user is provided with a plurality of shapes such as a circle, square, rectangle, and the like, that can be used to define the boundary of the custom zone.

The user also provides dimensions of the selected shape to create the custom zone. For example, if the user selects a circle to define the boundary, the user defines the radius of the circle. In the present embodiment, the location of the user when the custom zone is created is used as the centre of each shape. It will, however, be apparent that the centre of the custom zone can be modified by the user so that it does not need to be symmetrical about the user's location. Alternatively, the selected shape is overlaid on the map and the user can manipulate the size and location of the shape using standard graphical manipulation techniques.

In step 308, once the custom zone has been defined, the user can associate one or more of a plurality of different multimedia data with it. For the purpose of the present description, the term multimedia data refers to data that may comprise one or many different forms. Accordingly, some multimedia data may include only one type of data, such as text for example. Conversely, other multimedia data may include a number of different forms such as video (in formats such as avi, mpeg, asf, and the like), audio (in formats such as mp3, wav, midi, cell phone rings and the like), images (in formats such as jpeg, gif tiff, and the like), and document files (for applications such as Microsoft Word, Microsoft Excel, Adobe Acrobat and the like) as well as text. The type of data included in the multimedia data associated with each of the custom zone is, primarily, defined by the user. In the present embodiment, the created custom zone and its associated multimedia data are stored in the persistent store on the mobile device 102.

In one example, the user creates a “home” zone for the user's home. The user can associate one or more pictures of the home or of the user's family with the home zone. Similarly, the user could supply a task list of tasks to perform around the home. In another example, the user creates a “restaurant” zone for a restaurant. The user can associate one or more pictures of the restaurant with the restaurant zone. Similarly, the user could provide notes on the restaurant, including food quality, service, price and the like.

The multimedia data associated with the custom zone can be created on the mobile device or retrieved from another source. For example, many mobile devices 102 are capable of capturing pictures and/or video. Further, notes can be created using the input device of the mobile device 102. Alternatively, multimedia data can be retrieved via an Internet browser or from e-mail, Multimedia Messaging Service (MMS) messages, and the like, received on the mobile device 102. It will be appreciated that the type of information associated with a custom zone is left to the user's discretion and may be limited only by the capability of the mobile device 102.

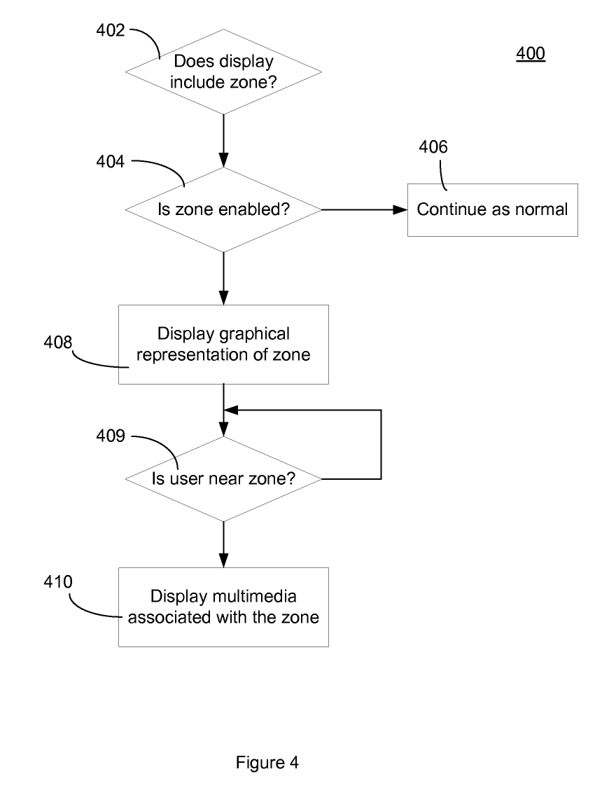

In step 310, the user can choose whether to have the custom zone enabled or disabled. Whether or not the custom zone is enabled will affect the operation of zone application as will be described in detail with reference to FIG. 4.

In an alternate embodiment, when the zone application prompts the user for a name and boundary 306, the user is provided with a lasso tool for defining the boundary of the custom zone. A lasso tool is a well known image editing tool that enables the user to perform freehand selection of an irregular shape that does not necessarily conform with a predefined shape.

In yet an alternate embodiment, when the zone application prompts the user for a name and boundary 306, the user defines the boundary of the custom zone by motion. In this embodiment, the mobile device 102 tracks the user's movement to define the boundary of the custom zone. Accordingly, the user is able to create custom zones of any size and shape depending on the movement.

Optionally, for the previous two embodiments, the zone application includes a smoothing/snap feature. Such a feature is common in design applications for completing a custom shape or area. If, for example, the boundary of the custom zone does not end where it started, the custom zone will not encompass an enclosed area. Therefore, the smoothing/snap feature joins the end point of the boundary to the start point of the boundary, creating an enclosed custom zone. The smoothing/snap feature may further modify the custom boundary to form an actual geographic shape if possible and if desired. The actual geographic shape created by the smoothing/snap feature most closely represents the custom shape created by the user.

Once custom zones have been created, they can be used by the zone application to display information, other than basic map information to the user. Referring to FIG. 4, a flow chart illustrating the steps used to implement the custom zone in accordance with an embodiment is shown generally by numeral 400.

In step 402, the zone application determines when an area defined by one of the custom zones is displayed on the screen of the mobile device 102 as a result of tracking or panning. That is, depending on the scale of the map being displayed by the mapping application, the zone application determines when a portion of the map being displayed includes a custom zone.

In step 404, the zone application determines whether or not the custom zone is enabled.

If the custom zone is disabled, the zone application continues to step 406 and the area represented by the custom zone is displayed on the screen in a matter that is standard for the mapping application.

If the custom zone is enabled, the zone application continues to step 408 and displays a graphical representation of the area represented by the custom zone in order to identify the custom zone to the user. As will be appreciated, how the custom zone is represented can very depending on user preferences, zone application specifics, and the definition of the custom zone itself. In one embodiment, the custom zone boundary defined by the user is shaded or coloured on the map. In another embodiment, the custom zoned is represented on the map by an icon. For example, the “home” zone can be represented by a house icon and the “work” zone can be represented by a building icon.

In step 409, once the representation of the custom zone is shown on the map, the user navigates toward the custom zone. In the present embodiment this can be achieved in two ways. In a first approach, the user can physically travel to the custom zone. The mapping application tracks the user's progress and determines when the user enters the custom zone. In a second the user can pan the map to the location of the custom zone.

In step 410, the multimedia data associated with the custom zone is presented to the user. It will be appreciated that the multimedia data may be presented when the user is within a predefined distance of the custom zone or when the user is within the boundary of the custom zone. As previously described, the multimedia data may include, for example, pictures, video, descriptions, address information and other predefined information.

Further, as will be appreciated, the multimedia data may be displayed to the user a number of different ways. In one embodiment, the multimedia data replaces the map on the display of the mobile device 102. In another embodiment, the multimedia data is overlaid on top of the map. In this embodiment, the map may be faded or dimmed so that it does not detract too much attention from display of the multimedia data. For both of these embodiments, the user is optionally provided with a button, hot-key, or other input option via the GUI to return to a “map only” view.

Accordingly, it will be appreciated that the embodiments as described above provide the user with an enjoyable interface to the mapping application that provides custom information in addition to positioning information.

Although the previous embodiments described creating a location on the mobile device, it will be appreciated that the zones can be created “remotely”, for example at the user's primary computer. In such an example, the custom zones can be loaded onto the mobile device 102 over-the-air or by a wired connection such a Universal Serial Bus (USB) cable when the mobile device 102 is synchronized with the user's primary computer.

Further, although the previous embodiments provide examples of relatively small custom zones, such as the user's home, work or a restaurant, it will be appreciated that the size of the custom zone can vary, as defined by the user when creating the custom zone.

Yet further, the previous embodiments describe a zone application in which the custom zones and their associated multimedia data are stored on the mobile device 102. In an alternate embodiment, the multimedia data and/or custom zone definition information are stored on a central data store, such as the server 108 or the location based server 108a, for example, or in a database readily accessible by the server 108 or the location based server 108a. Each user is provided with an account and assigned a storage area for storing their information. Storing the multimedia data and/or custom zone definition information at the location based server 108b provides the ability to store more data than storing it on the mobile device 102. Memory space on many mobile devices 102 is limited and relatively expensive compared to storage on servers 108. Accordingly, the user would be able to define a large number of custom zones and associate much multimedia data with each custom zone.

Once the custom zone has been created, custom zone definition information and its corresponding multimedia data are delivered to the location based server 108a. The user can add or modify the multimedia data, or make modifications to the custom zone definition, which will be delivered to the location based server 108a as an update.

In one embodiment, standard text data such as the GPS coordinates, the boundaries, notes, addresses and the like are delivered to the location based server 108a over-the-air. More bandwidth intense data such as pictures and video, for example, are delivered to the location based server 108a via a broadband connection, using a wireless or a wired connection. For example, if the mobile device 102 has Wi-Fi capability, a Wi-Fi hotspot or other connection is used to transfer the data. Alternatively, a wired connection such as USB or Firewire cable to a computer having a broadband network connection may be used to transfer the data.

In an alternate embodiment, both the standard text data and the bandwidth intense data are delivered to the location based server 108a over-the-air. In yet an alternate embodiment, both the standard text data and the bandwidth intense data are delivered to the location based server 108a via a broadband connection.

The location based server 108a stores the data for retrieval by the mobile device 102. Optionally, the location based server 108a compresses any images and/or video to thumbnails and/or a resolution compatible with the mobile device 102. It will be appreciated by a person skilled in the art that a picture or video used for a custom zone may exceed the resolution capabilities of the mobile device 102. Accordingly, the location based server 108a prepares a version of such files that are optimized for the mobile device 102. The original version is maintained on the location based server 108a, should the user request access to it.

Once the custom zone information and its associated multimedia data is synchronized between the mobile device 102 and the location based server 108a, the information can be removed from the mobile device 102 if desired.

In the present embodiment, the location based server 108a includes a version of the zone application executing in parallel with, or as part of, its mapping service application. Accordingly, when the location based server 108a sends mapping data to the mobile device 102, it follows step 402-408 described with reference to FIG. 4.

The zone application determines when an area defined by one of the custom zones is to be displayed on the screen of the mobile device 102. That is, in accordance with the user's location, does the mapping information to be sent to the mobile device 102 include a custom zone.

If the custom zone is located within the mapping data to be sent, the zone application determines whether or not the custom zone is enabled. If the custom zone is disabled, the custom zone is treated the same as the rest of the mapping information. If the custom zone is enabled, the zone application provides a graphical representation of the custom zone as part of the mapping information.

In the present embodiment, the zone application also transmits the multimedia data associated with the custom zone. In an alternate embodiment, the location based server 108b communicates with the mobile device 102 to determine whether or not the multimedia data is already cached on the mobile device 102. If the multimedia data is cached, it is not retransmitted unless explicitly requested by the user.

In the embodiment described above, the custom zone information is stored on the location based server 108a and the mobile device 102 determines when the user approaches a custom zone. In an alternate embodiment, the location based server 108a determines when the user approaches a custom zone. This embodiment reduces the demands of the mobile device 102, as it would not require that the zone application be installed on the mobile device 102 nor that the mobile device 102 be aware of the custom zone.

It will be appreciated that by storing the custom zone definition information and associated multimedia data on a central server, size limitations of memory intensive media are reduced. Further, the mobile device 102 is fault tolerant as the custom zones are saved remotely and associated with the user. Yet further, the user can switch mobile devices 102 or work on a personal computer to create or view the custom zones.

Although a number of different embodiments are described above, it will be appreciated by a person of ordinary skill in the art that various combinations of the different embodiments may also be implemented.

Further, although the invention has been described with reference to certain specific embodiments, various modifications thereof will be apparent to those skilled in the art without departing from the scope of the invention as defined by the appended claims.

1. A method of creating a custom zone for providing an improved graphical user interface to a user of a mapping application on a mobile device, the method comprising the steps of:
requesting creation of the custom zone;
establishing a location of the custom zone;
defining a boundary for the custom zone; and
associating multimedia data with the custom zone for subsequent display to the user.

2. The method of claim 1 wherein the boundary is defined by the user selecting an area on the map using a selection tool.

3. The method of claim 2 wherein the selection tool comprises a predefined shape selector.

4. The method of claim 2 wherein the selection tool comprises a lasso tool.

5. The method of claim 1 wherein the multimedia data is created on the mobile device.

6. The method of claim 1 wherein the multimedia data includes at least one of video, audio, image, document file, or text data.

7. A computer readable medium comprising instructions which, when executed on a computing device cause the computing device to implement the method of claim 1.

8. The computer readable medium of claim 7 wherein the computing device is a server.

9. The computer readable medium of claim 7 wherein the computing device is a mobile device.

10. A system for providing an improved graphical user interface to a user of a mapping application on a mobile device for identifying a predefined custom zone on a map, the system comprising a processor configured to implements the steps of:
determining that the custom zone is included in a portion of the map to be displayed by the mapping application; and
retrieving multimedia data associated with the custom zone for display to the user.

11. The system of claim 10 wherein the multimedia data is displayed to the user when the user is within a boundary of the custom zone.

12. The system of claim 10 wherein the multimedia data is displayed to the user when the user graphically manipulates the map to be within a boundary of the custom zone.

13. The system of claim 10 being implemented at a server.

14. The system of claim 10 being implemented at the mobile device.

15. The system of claim 10 wherein the multimedia data includes at least one of video, audio, image, document file, or text data.

16. A method for providing an improved graphical user interface to a user of a mapping application on a mobile device for identifying a predefined custom zone on a map, the method comprising the steps of:
determining that the custom zone is included in a portion of the map to be displayed by the mapping application; and
retrieving multimedia data associated with the custom zone for display to the user.

17. The method of claim 16 comprising the further step of displaying an visual indicator to the user to illustrate the custom zone.

18. The method of claim 17, wherein the visual indicator is displayed by shading an area defined by the custom zone.

19. The method of claim 17, wherein the visual indicator is displayed by presenting an icon at the custom zone.

20. The method of claim 16, wherein the multimedia data is displayed when the user is within a boundary of the custom zone.

21. The method of claim 16, wherein the multimedia data is displayed when the user graphically manipulates the map to be within a boundary of the custom zone.

22. The method of claim 16 comprising the further step of determining whether the custom zone is enabled or disabled and only retrieving the multimedia data if the custom zone is enabled.

23. The method of claim 16, wherein the step of determining that the custom zone is included in a portion of the map is performed at a server remote from the mobile device.

24. The method of claim 23, wherein custom zone information and the multimedia data are stored at the server.

25. The method of claim 24 comprising the further step of transmitting the custom zone information to the mobile device along with standard mapping information.

26. The method of claim 25 comprising the further step of determining whether the custom zone is enabled or disabled and only transmitting the custom zone information to the mobile device if the custom zone is enabled.

27. The method of claim 24 comprising the further step of creating a scaled version of the multimedia data in accordance with the capability of the mobile device and transmitting the scaled multimedia data along with standard mapping information.

28. The method of claim 24 wherein the custom zone information and the multimedia information are synchronized between the mobile device and the server over-the-air.

29. The method of claim 24 wherein the custom zone information and the multimedia information are synchronized between the mobile device and the server using a broadband connection.

30. The method of claim 29 wherein the broadband connection is wireless.

31. The method of claim 16 wherein the multimedia data includes at least one of video, audio, image, document file, or text data.
